(19) United States
(12) Patent Application Publication
(10) Pub. No.: US 2006/0289633 A1
(43) Pub. Date: Dec. 28, 2006

(54) Receipts having dual-sided thermal printing

(75) Inventors: Richard B. Moreland, Centerville, OH (US); Richard D. Puckett, Miamisburg, OH (US); Maryann Wehr, Hamilton, OH (US)

Correspondence Address: DOUGLAS S. FOOTE;NCR CORPORATION, 1700 S. PATTERSON BLVD. WHQ5E, WHO-5E, DAYTON, OH, 45479, US

(73) Assignee: NCR Corporation

(21) Appl. No.: 11/159,461

(22) Filed: Jun. 23, 2005

(51) Int. Cl. G06F 7/08

(52) U.S. Cl. 235/381

(57) ABSTRACT

Variable information printed on both sides of a paper receipt at transaction time saves materials and provides flexibility in providing information to the recipient. Direct thermal printing on both sides of a paper receipt when issued is described. Using opposed print heads, paper receipts are printed on both sides at transaction time in a single pass. With transaction item detail printed on the front side of a double-sided thermal paper receipt, different types of information printed on the reverse side are described, including rebate information, contest information, serialized cartoons, conditions of sale, promotional information, coupon information, security features, ticket information and custom information based on recipient identity or transaction data or detail.

### BACKGROUND

Transaction receipts have been used to include information in addition to transaction item detail, such as store logos, advertisements, rules and regulations, etc. Preprinted information has been included on the backside of receipt paper while transaction item detail and supplemental information have been printed on the front side of receipts when transactions are consummated. Supplemental information such as coupons has been printed separately from receipts and given to customers at transaction time as well.

Printing at transaction time adds flexibility to the type of supplemental information that might be directly added to paper receipts. However excessive printing on the front sides of receipts can sometimes be wasteful of paper or distracting to recipients.

Traditional receipts for automated financial and retail transactions have generally used low cost printing technologies to conserve ownership costs, thus limiting the types of printing solutions that would be practical to offer. However, dual-sided thermal imaging, e.g., as described in U.S. Pat. Nos. 6,784,906 and 6,759,366, expands the opportunities by which two-sided receipts might reasonably be commercially printed.

### SUMMARY

Variable information printed on both sides of a paper receipt at transaction time saves materials and provides flexibility in providing information to the recipient. Direct thermal printing on both sides of a paper receipt when issued is described. Using opposed print heads, paper receipts are printed on both sides at transaction time in a single pass.

With transaction item detail printed on the front side of a double-sided thermal paper receipt, different types of information printed on the reverse side are described, including rebate information, contest information, serialized cartoons, conditions of sale, promotional information, coupon information, security features, ticket information and custom information based on recipient identity or transaction data or detail.

Other advantages and features will become apparent based on the further description and appended claims to follow.

### BRIEF DECRIPTION OF THE DRAWINGS

FIG. 1 shows a schematic of a dual-sided imaging direct thermal printer useable for dual-sided, single pass printing of transaction receipts or tickets at time of issue.

FIG. 2A shows receipt with transaction detail printed on the front side.

FIG. 2B shows a transaction receipt with supplemental information printed on the reverse side, such as variable information determined at the time of the transaction.

### DESCRIPTION

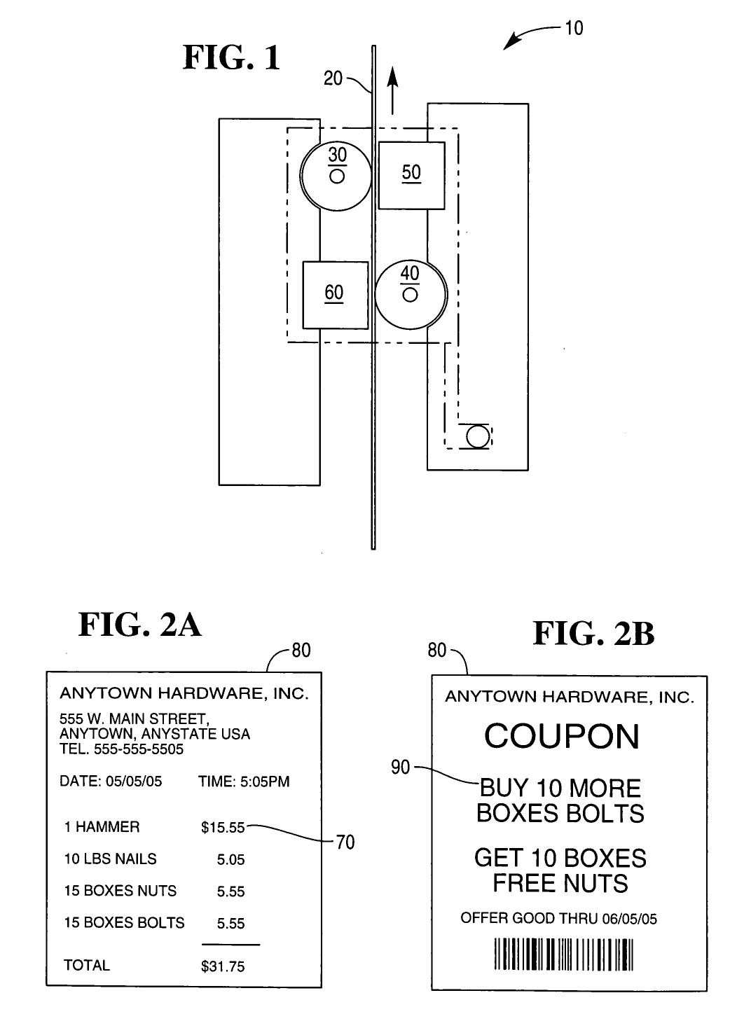

FIG. 1 shows a schematic of a dual-sided imaging direct thermal printer 10 useable for dual-sided, single pass printing of transaction receipts or tickets at time of issue. The printer 10 operates on receipt media 20 which is double-sided thermal paper, e.g., comprising a cellulosic or polymer substrate sheet coated on each side with heat sensitive dyes as described in U.S. Pat. Nos. 6,784,906 and 6,759,366. Multi-color printing capability can be provided on both sides of the receipt by using two or more dyes with sensitivity to different temperatures on a side where multi-color printing is desired. Substrates and heat sensitive color changing coatings for direct thermal printing media are generally well known in the art. Dual-sided direct thermal printing can be facilitated by a media 20 which includes dyes sensitive to different temperatures on opposite sides of the media 20, or by use of thermally resistant substrates to inhibit thermal printing on one side of the media 20 from affecting the coloration on the opposite side of the media 20.

As shown in FIG. 1, the printer 10 has rotating platens 30 and 40 and opposing thermal print heads 50 and 60 on opposite sides of the receipt or ticket media 20. Dual-sided direct thermal printing of the media 20 occurs in a single pass at the time of the transaction or when a receipt or ticket is issued. The media 20 is cut or severed to provide an individual receipt or ticket document, typically once printing is completed.

FIG. 2A shows transaction detail 70 such as issuer identification, time, date, line item entries and a transaction total printed on the front side of a receipt 80. FIG. 2B shows custom information 90, e.g., based on recipient identity or transaction detail ascertained at transaction time, printed on the reverse side of the receipt 80. For example, custom information 90 could include further or duplicate transaction information, a coupon as shown, rebate or contest information, serialized cartoons, conditions of sale, document images, advertisements, security features, ticket information, or other information, e.g., custom information based on recipient identity or transaction data or detail.

Printing of contest or rebate information on receipts provides simplicity and convenience of benefit to consumer. Printing of such variable information on the reverse side of the receipt, e.g., based on an automated identification of a product being sold, results in more compact, lower paper cost documents for customer use. The transaction detail can be duplicated on the front or back side of a receipt, e.g., to support a rebate or contest application while allowing the customer to sever a printed copy for retention. For example, the transaction detail could be duplicated on the front side of the receipt, with rebate directions printed on the reverse side opposite one of the transaction detail copies. The receipt is then severed into two pieces with one transaction detail copy on one piece, and the other transaction detail copy on the second piece with rebate directions printed on the other side. This second piece of the receipt is then mailed for rebate processing.

Having a serialized cartoon on the reverse of a retail receipt containing product references could stimulate interest in the product or the retailer. Given proper content, the serialization could generate its own following, thus adding a stimulant for further sales. A receipt printed using double-sided thermal paper with receipt transaction detail printed on one side and a cartoon of a serialized nature printed on the other side could be customized on the fly to include product placement text dependent on the purchases made.

Use of two-sided direct thermal paper allows terms and conditions to be printed directly on the back of a receipt at the same time that the receipt is issued. Printing on the spot allows the terms and conditions, such as return policies, to be tailored to the item being sold. For example, the terms and conditions for an appliance may be different than the terms and conditions for electronic equipment. Printing is controlled to ensure that the entire set of appropriate terms and conditions is on the receipt, and is not cut off either at the top or bottom. Use of two-sided thermal media is anticipated to be less expensive than pre-printed paper, and should reduce lead times for the receipt media from suppliers.

Printing of coupons or store promotional information along with a receipt has involved printing the receipt followed by the coupons or promotional information being printed. Alternatively, coupons, advertisements or other promotional information have been pre-printed on the back of receipt paper using a printing press or digital press. One example of such pre-printing is the Catalina coupon printer. Use of two-sided direct thermal paper allows the coupon or promotional information to be printed directly on the back of the receipt at the time that the receipt is being issued. This can save transaction time and reduce paper requirements, compared with printing receipts and promotional information on separate pieces of paper. Again, compared with having supplemental information pre-printed, use of two-sided thermal media should be less expensive and reduce lead time for the receipt media from suppliers. The dual-sided printing also allows variable or custom information to be ascertained and printed at transaction time where information pre-printing does not.

Double-side thermal paper receipts with color on one side and black on the other side, or other different colors of printing on each side, differentiates or accentuates particular text. The technique has use for stressing warranty or guarantee particulars, warnings, or specific conditions or events, etc. Double-sided thermal receipt paper with one or both sides in two or more thermally active colors on a side allows for such accentuation of text where desired.

Tickets for events like concerts, sporting events, traveling shows (such as the circus), etc. have often been either sold on site or by ticket agencies, and must be purchased in advance in order to be mailed. Tickets, a form of receipt, have been pre-printed for particular venues, and often have security features on the ticket to prevent fraudulent duplication. This practice can limit the number of locations where tickets are available, often resulting in long lines or long waits on the telephone when tickets are in demand. In addition, the number of different venues where a vendor can sell tickets can be limited where a separate set of tickets is required to be printed for each venue.

Use of two-sided direct thermal paper allows for flexible printing of tickets for any venue, since the venue specific information could be printed, as well as a security feature such as a specific barcode, ID number, or even color (e.g., using 2 color thermal printing on the one side). If one tried to print all required information on a one-sided thermal ticket, the ticket could be unwieldy in size, or the font size could need to be so small as to affect legibility. Use of two-sided direct thermal paper ticket allows anyone to purchase flexibly printed tickets, e.g., at a self-service kiosk, which could increase availability and potentially result in the sale of more tickets.

Supplemental or customized information can be automatically determined and thermally printed based on customer identifications, product information, transaction detail, historical data or the like data as may be captured, recovered or calculated using information technology systems. For example, supplemental or customized information is based on data provided by a computerized database look-up or transaction data entries, e.g., including transaction data scanned or manually entered by a service agent or customer.

The text above sets forth a number of specific embodiments or examples of a broader invention. The invention is also carried out in a wide variety of other alternative ways which have not been described here. Many other embodiments of the invention are also within the scope of the following claims.

What is claimed is:

1. A method of issuing a receipt which comprises printing on both sides of receipt media in a single pass, using opposed print heads, when the receipt is issued.

2. The method of claim 1 in which the media is double sided thermal paper.

3. The method of claim 1 in which the media is printed by direct thermal printing.

4. The method of claim 1 in which transaction data is printed on one side of the receipt and rebate information is printed on the other side of the receipt.

5. The method of claim 5 in which the transaction data is printed on both sides of the receipt, where on one side the transaction data is printed with the rebate information.

6. The method of claim 1 in which transaction data is printed on both sides of the receipt.

7. The method of claim 1 in which transaction data is printed on one side of the receipt and contest information is printed on the other side of the receipt.

8. The method of claim 7 in which the transaction data is printed on both sides of the receipt, where on one side the transaction data is printed along with the contest information.

9. The method of claim 1 in which transaction data is printed on one side of the receipt and a serialized cartoon is printed on the other side of the receipt.

10. The method of claim 9 in which the serialized cartoon is customized based on transaction data.

11. The method of claim 10 in which the serialized cartoon presents product information based on the subject matter of a transaction.

12. The method of claim 1 in which transaction data is printed on one side of the receipt and customized information based on transaction data is printed on the other side.

13. The method of claim 1 in which transaction data is printed on one side of the receipt and conditions of sale are printed on the other side of the receipt.

14. The method of claim 13 in which the conditions of sale are tailored according to the type of an item being sold.

15. The method of claim 1 in which transaction data is printed on one side of the receipt and promotional information is printed on the other side of the receipt.

16. The method of claim 15 in which the promotional information is coupon information.

17. The method of claim 1 in which a color of the printing on one side of the receipt is different from a color of printing on the other side of the receipt.

18. The method of claim 17 in which the color on one side of the receipt accentuates a particular subject matter of text printed o the receipt.

19. The method of claim 17 in which the media is double sided thermal paper with different thermally active colors on each side of the receipt.

20. The method of claim 17 in which the printing is in at least two colors on one side of the receipt.

21. The method of claim 1 in which ticket information is printed on one side of the receipt and a security feature is printed on the other side of the receipt.

22. The method of claim 21 in which the security feature is a barcode.

23. The method of claim 21 in which the security feature is an identification code.

24. A method of conveying transaction information to a customer, comprising:
(1) enabling consummation of a transaction with a customer; (2) enabling printing on both sides of receipt media using opposed print heads in a single pass at the time of the transaction, thereby creating a receipt where transaction data is printed on both sides of the receipt; and (3) enabling issuance of the receipt to the customer.

25. The method of claim 24 in which the transaction data printed on one side of the receipt is different from the transaction data printed on the other side of the receipt.

26. A method of promoting commerce with a customer, comprising: (1) enabling consummation of a transaction with the customer; (2) enabling printing on both sides of receipt media at the time of the transaction, thereby creating a receipt where transaction data is printed on one side of the receipt and promotional information is printed on the other side of the receipt; and (3) enabling issuance of the receipt to the customer.

27. The method of claim 26 in which the promotional information is based on transaction data resulting from business with the customer.

28. A method of conveying transaction terms to a customer, comprising: (1) enabling consummation of a transaction with a customer; (2) enabling printing on both sides of receipt media at the time of the transaction, thereby creating a receipt where transaction data is printed on one side of the receipt and the transaction terms are printed on the other side of the receipt; and (3) enabling issuance of the receipt to the customer.

29. The method of claim 28 in which the transaction terms to be printed are selected at the time of the transaction according to transaction data.

30. The method of claim 29 in which the transaction terms to be printed are selected at the time of the transaction according to a type of product being sold to the customer.

31. A method of issuing a ticket, which serves as a receipt, comprising: (1) enabling consummation of a ticket transaction with a customer; (2) enabling thermal printing on both sides of ticket media at the time of the transaction, thereby creating a ticket where ticket transaction data is printed on both sides of the ticket; and (3) enabling issuance of the ticket to the customer.

32. The method of claim 31 in which the ticket transaction data printed on one side of the ticket comprises a security feature.

33. The method of claim 32 in which the security feature is a barcode.

34. The method of claim 32 in which the security feature is an ID number.

35. The method of claim 32 in which the security feature is a color of printing.

36. A transaction receipt comprising a substrate sheet material with thermally sensitive color changing coatings on both sides and transaction data thermally printed on one side and supplemental information thermally printed on the other side.

37. A receipt as set forth in claim 36 in which the receipt is a ticket having ticket information thermally printed on both sides of the receipt.

38. A receipt as set forth in claim 37 in which the receipt includes a thermally printed security feature on at least one side of the receipt.
